(19) United States
(12) Patent Application Publication
(10) Pub. No.: US 2021/0364471 A1
(43) Pub. Date: Nov. 25, 2021

(54) Method for Creating an Evaluation Table for an Ultrasonic Inspection and Method for Ultrasonic Inspection

(71) Applicant: Siemens Aktiengesellschaft, München (DE)

(72) Inventors: Johannes Vrana, München (DE); Hubert Mooshofer, München (DE); Matthias Goldammer, München (DE); Alexander Seeber, München (DE)

(73) Assignee: Siemens Aktiengesellschaft, München (DE)

(21) Appl. No.: 16/625,519

(22) PCT Filed: Jun. 4, 2018
(86) PCT No.: PCT/EP2018/064578

§ 371 Date: Dec. 20, 2019

(30) Foreign Application Priority Data
Jun. 27, 2017 (DE) 10 2017 210 755.3

(51) Int. Cl. G01N 29/06; G01N 29/44; G01N 29/04

(52) U.S. Cl. CPC G01N 29/069; G01N 29/4427; G01N 2291/044; G01N 29/043; G01N 2291/0289; G01N 29/4472

(57) ABSTRACT

Various embodiments include a method for creating an evaluation table for an ultrasonic inspection of an object comprising: simulating a scattering of ultrasound on a defect having an established defect size using a computer-implemented two-dimensional or three-dimensional simulation, wherein the defect size is less than or equal to the wavelength of the ultrasound and the simulation takes into consideration a mode conversion of the ultrasound by the defect; ascertaining the reflectivity of the defect from the simulation; and creating the evaluation table by means of an assignment of the ascertained reflectivity to the established defect size of the defect.

### CROSS-REFERENCE TO RELATED APPLICATIONS

This application is a U.S. National Stage Application of International Application No. PCT/EP2018/064578 filed Jun. 4, 2018, which designates the United States of America, and claims priority to DE Application No. 10 2017 210 755.3 filed Jun. 27, 2017, the contents of which are hereby incorporated by reference in their entirety.

### TECHNICAL FIELD

The present disclosure relates to ultrasonic testing. Various embodiments of the teachings herein include methods for creating an evaluation table for an ultrasonic inspection of an object, in particular a component and/or methods for ultrasonic inspection of an object, in which an evaluation table created according to the invention is used to evaluate indications, in particular defects, acquired during the ultrasonic inspection.

### BACKGROUND

Typically, the evaluation of small indications in an ultrasonic inspection is performed by means of a comparison of an ultrasonic amplitude (also referred to as the amplitude or echo) reflected from a defect or flaw on which the indication is based to an indication of an artificially produced defect. In this case, an indication is referred to as small if its size is less than the sound bundle of the incident ultrasound. The artificially produced defects can be formed as flat bottom holes, lateral holes, or circular disks. An indication and/or a defect within the object may be assigned a value referred to as an equivalent defect size by way of the mentioned comparison. In this case, the equivalent defect size specifies how large a comparably reflective artificially produced defect is. Accordingly, the actual geometrical size or extension of the defect inside the object cannot necessarily be concluded from the equivalent defect size.

An exemplary evaluation of a defect is therefore provided, for example, by the following statement: The indication and/or the defect reflects like a circular disk having a diameter of 4 mm.

A use of known methods for determining equivalent defect sizes is only possible with sufficient accuracy to a minimal defect size, wherein the minimal defect size is essentially established by the wavelength of the incident ultrasound. In the case of smaller defect sizes, i.e., in the case of defect sizes which are less than the wavelength of the ultrasound used, known equivalent defect sizes which are based on holes, for example, can only be used inadequately.

This is the case because such holes having small diameter are typically significantly larger in the respective hole direction thereof than the wavelength of the incident ultrasound. They thus cannot be utilized as a usable reference, i.e., as an equivalent defect size. In addition, the production and preparation of such small holes is problematic. The production of defined ultrasound reflectors and thus the provision of equivalent defect sizes is thus only possible for large defect sizes, which are hardly relevant in practice, however.

Furthermore, known equivalent defect sizes are based on mathematical models. However, the known mathematical models presume a scaling of the reflectivity proportional to the reflective area of the defect. Since the mentioned proportionality can exclusively be assumed for defect sizes above the wavelength, known mathematical models are not applicable in the case of defects having a defect size smaller than the wavelength. Higher frequencies could be used to resolve smaller defect sizes. However, this results in elevated absorption of the utilized ultrasound (sound attenuation), so that defects are more difficult to detect.

### SUMMARY

The teachings of the present disclosure may be used to improve the detection of small defects in an object, in particular in a component, during an ultrasonic inspection. For example, some embodiments of the teachings herein include a method for creating an evaluation table for an ultrasonic inspection of an object, comprising the following steps: simulating a scattering of ultrasound on at least one defect having an established defect size by means of a computer-implemented two-dimensional or three-dimensional simulation, wherein the defect size is less than or equal to the wavelength of the ultrasound, and the simulation takes into consideration a mode conversion of the ultrasound by the defect; ascertaining the reflectivity of the defect from the simulation; and creating the evaluation table by means of an assignment of the ascertained reflectivity to the established defect size of the defect.

In some embodiments, a simulation based on finite differences, in particular an elastodynamic finite integration method, is used as the simulation.

In some embodiments, the Auld reciprocity theorem is used to ascertain the reflectivity.

In some embodiments, the simulation is exclusively performed in a subregion of the object surrounding the defect.

In some embodiments, the simulation of the propagation of the ultrasound from its incidence position to the subregion is performed by means of an elastodynamic point source synthesis.

In some embodiments, the reflectivity is ascertained by means of

$$R = {( \frac{π D}{16 s} )}^{2} \vert \frac{{( ix )}^{3}}{\sqrt{1 + \frac{ix}{Q} - {x}^{2}}} \vert \qquad$$

wherein x=4D_{f}/λ, and D_{f} denotes the defect size, D denotes an oscillator diameter of a test head, λ denotes the wavelength of the ultrasound, Q denotes a fit parameter, and s denotes the sound path.

In some embodiments, the reflectivity is approximately ascertained by means of

$$R \approx \frac{{x}^{3}}{\sqrt{\vert 1 + ix - {x}^{2} \vert}} \cdot {( \frac{π D}{16 s} )}^{2} .$$

In some embodiments, a validation of the simulation is performed by means of a comparison ultrasonic inspection on at least one produced defect, wherein the defect size of the produced defect is greater than the wavelength of the ultrasound used during the comparison ultrasonic measurement.

In some embodiments, the evaluation table is ascertained as a diagram or formula expression.

As another example, some embodiments include a method for the ultrasonic inspection of an object, comprising the following steps: radiating ultrasound onto at least one volume element of the object; acquiring at least one ultrasound reflected from the volume element because of at least one defect; determining the reflectivity by means of the absolute value of a time-dependent amplitude of the reflected ultrasound for the volume element; and ascertaining a defect size associated with the determined reflectivity by means of an evaluation table created as described above.

In some embodiments, the determination of the reflectivity is based on a SAFT analysis.

### BRIEF DESCRIPTION OF THE DRAWINGS

Further advantages, features, and details of the teachings herein are illustrated in light of exemplary embodiments described hereafter and on the basis of the drawings. In the schematic figures:

FIG. 1 shows a schematic flow chart of the method incorporating teachings of the present disclosure for creating an evaluation table for an ultrasonic inspection; and

FIG. 2 shows a comparison diagram of a simulation with a formula expression.

Identical, equivalent, or identically-acting elements can be provided with the same reference signs in the figures.

### DETAILED DESCRIPTION

Some embodiments of the teachings herein may be used for creating an evaluation table for an ultrasonic inspection of an object, in particular a component. For example, some embodiments include methods comprising at least the following steps:
simulating a scattering of ultrasound on at least one defect having an established defect size by means of a computer-implemented two-dimensional or three-dimensional simulation, wherein the defect size is less than or equal to the wavelength of the ultrasound, and the simulation takes into consideration a mode conversion of the ultrasound by the defect;
ascertaining the reflectivity of the defect from the simulation; and
creating the evaluation table by means of an assignment of the ascertained reflectivity to the established defect size of the defect.

The geometrical size of a defect, in particular a defect used and designed in the simulation, perpendicularly to the incidence direction of the ultrasound is referred to as the defect size. A defect as used in the present disclosure is small if its defect size is less than or equal to the wavelength, in particular less than or equal to half the wavelength, of the employed ultrasound. In other words, the defect has a geometrical extension at least in one direction which is less than or equal to the wavelength of the employed ultrasound. The simulation can be implemented by means of a processing device, in particular by means of a computer. The further steps of the methods described herein can also be executed by means of a processing device.

A three-dimensional simulation is performed in the case of objects which do not have spatial symmetry. A two-dimensional simulation can be provided in the case of objects having a spatial symmetry, for example, in the case of an object formed as a rotation body. Processing time can be saved by the two-dimensional simulation. The two-dimensional and three-dimensional simulation can furthermore comprise a time sequence of the scattering procedure.

In some embodiments, the reflectivity of the defect having a defect size less than the wavelength of the ultrasound is ascertained by means of the simulation. For this purpose, the simulation comprises a numeric computation of the scattering of the ultrasound at the employed defect. In some embodiments, the simulation takes into consideration a mode conversion of the ultrasound by its scattering at the defect. The mentioned scattering procedure is thus physically simulated as completely as possible by the simulation. The simulation provides as a result at least one time-dependent amplitude of the ultrasound (echo) reflected at the defect, from which the reflectivity can be ascertained.

The evaluation table is created by the assignment of the ascertained reflectivity to the established defect size of the defect. In other words, an equivalent defect size is assigned to the ascertained reflectivity. A defect size evaluation of fundamentally arbitrarily small indications or defects can thus advantageously be performed. If a determined experimental reflectivity of a defect in the object is acquired during an ultrasonic inspection of an object, this experimentally acquired reflectivity can thus be compared to the ascertained and/or computed reflectivity within the evaluation table according to the invention. The ascertained reflectivity is assigned according to the invention a defect size and/or an equivalent defect size, so that an equivalent defect size is also assignable to the experimentally acquired reflectivity and thus the real defect by the mentioned comparison. A sufficiently accurate equivalent defect size can thus be assigned to small defects.

This is the case, on the one hand, because the simulation of the method according to the invention takes into consideration the mode conversions of the ultrasound at the defect. In other words, as a result of the scattering of the ultrasound at the defect, a change of the polarization of the incident ultrasound typically occurs, which the simulation takes into consideration. For example, longitudinal waves scattered at the defect (ultrasound longitudinally polarized) can be converted into transverse waves (ultrasound transversely polarized) and vice versa.

Some embodiments include a method for the ultrasonic inspection of an object comprising at least the following steps:
radiating ultrasound onto at least one volume element of the object;
acquiring at least one ultrasound reflected from the volume element because of at least one defect;
determining the reflectivity by means of the absolute value of a time-dependent amplitude of the reflected ultrasound for the volume element; and
ascertaining a defect size of the defect associated with the determined reflectivity by means of an evaluation table created according to the present invention or one of its designs.

Some embodiments include a method for ultrasonic inspection, wherein a SAFT analysis (synthetic aperture focus technique; abbreviated SAFT) is used in the determination of the reflectivity. In other words, the ascertainment of the reflectivity is based on a SAFT analysis (synthetic aperture focusing technique; abbreviated SAFT). The accuracy and the evaluation of defect sizes may thus be improved.

In some embodiments, a simulation based on finite differences is used as the simulation, in particular an elastodynamic finite integration method (elastodynamic finite integration technique, abbreviated: EFIT). The mentioned simulation method may be particularly advantageous for simulating and/or computing the most complete possible physical scattering of the ultrasound at a small defect. Further grid-based simulation methods can alternatively or additionally be provided, for example, a finite element method (abbreviated: FEM).

In some embodiments, the Auld reciprocity theorem is used to determine the reflectivity. For this purpose, for example, the propagation of the ultrasound (sound propagation) for its travel to the defect and its reflection at the defect is simulated by means of an EFIT simulation, and furthermore the propagation of the ultrasound is computed for its travel to the spatial position of the defect without a reflection at the defect. If the ultrasound field on an area enclosing the defect is known, the reflected amplitude and/or the reflectivity of the ultrasound—without simulating its return path—can thus be determined by means of the Auld reciprocity theorem. The processing time of the simulation may thus be reduced.

In some embodiments, the simulation is performed exclusively in a subregion of the object enclosing the defect. It is thus not necessary to simulate the volume of the entire object three-dimensionally. The processing time of the simulation can thus be further reduced without losing accuracy.

In some embodiments, the simulation of the propagation of the ultrasound from an incidence position to the subregion is performed by means of an elastodynamic point source synthesis. In other words, the propagation of the ultrasound is exclusively simulated in surroundings of the defect. The sound propagation from the incidence position (test head) to the simulated subregion is computed by means of the elastodynamic point source synthesis. The processing duration of the simulation may thus be further reduced. Further beam-based simulation methods can be provided.

In some embodiments, the reflectivity R is ascertained or fitted by means of

$$R = {( \frac{π D}{16 s} )}^{2} \vert \frac{{( ix )}^{3}}{\sqrt{1 + \frac{ix}{Q} - {x}^{2}}} \vert \qquad$$

wherein x=4D_{f}/λ, and D_{f} denotes the defect size, D denotes an oscillator diameter of a test head, λ denotes the wavelength of the ultrasound, Q denotes the fit parameter, and s denotes the sound path. The symbol i denotes the imaginary unit.

In other words, the following applies for a maximum value of the reflected amplitude

$$A - {{A}_{0} ( \frac{π D}{16 s} )}^{2} \vert \frac{{( ix )}^{3}}{\sqrt{1 + \frac{ix}{Q} - {x}^{2}}} \vert$$

wherein A₀ denotes a reference value of the maximum value. The reflectivity is given by the ratio |A/A₀|, so that R=|A/A₀| applies.

The above formula expression for the reflectivity is typically related to an amplification V (gain) used during the ultrasonic inspection by means of V=20·logₙ(R). In other words, the reflectivity is specified in the unit decibels.

The result of the simulation, i.e., in particular the reflectivity, may thus be described and fitted by means of an equation or a formula expression. An interpolation of the results of the simulation can thus be performed. Furthermore, the evaluation table can thus be supplemented by non-simulated data points. Moreover, the above formula expression is efficiently implementable, so that an immediate query and thus an immediate and rapid evaluation can be performed in an ultrasonic inspection.

Further equations or formula expressions which are comparable and/or mathematically equivalent and which reflect the results of the simulation as precisely as possible can be provided. In particular, a fit of the reflectivity can be performed on the basis of these further equations or formula expressions. Typically, the reflectivity is not directly fitted, but rather the amplification, i.e., the reflectivity specified in decibels. This is equivalent to a fit of the reflectivity.

For example, the above formula expression for the amplification V can be reformed as follows:

$$V = 20 \cdot {log}_{10} \vert \frac{A}{{A}_{0}} \vert = 20 \cdot {log}_{10} [ \frac{{x}^{3}}{\sqrt{\vert 1 + \frac{ix}{Q} - {x}^{2} \vert}} \cdot {( \frac{π D}{16 s} )}^{2} ]$$

Furthermore, resonance effects can advantageously be approximately neglected if necessary, which results in the approximation

$$V \approx 20 \cdot {log}_{10} [ \frac{{x}^{3}}{\sqrt{\vert 1 + ix - {x}^{2} \vert}} \cdot {( \frac{π D}{16 s} )}^{2} ]$$

wherein the variables and parameters are defined as above. In particular, x=4D_{f}/λ. In other words, the reflectivity is approximately ascertained by means of

$$R \approx \frac{{x}^{3}}{\sqrt{\vert 1 + ix - {x}^{2} \vert}} \cdot {( \frac{π D}{16 s} )}^{2}$$

The mentioned approximation is independent of the fit parameter Q, so that a fit is not required within the approximation. The above equations can be referred to as a theoretical model of the reflectivity of the ultrasound at the defect.

In some embodiments, a validation of the simulation is performed by means of a comparison ultrasonic inspection on at least one produced defect, wherein the defect size of the produced defect is greater than the wavelength of the ultrasound used during the comparison ultrasonic measurement. A calibration and/or validation or check of the simulation at large defects and thus at still producible defects may be performed in this way.

In some embodiments, the evaluation table is ascertained as a diagram or formula expression. An improved evaluation of a defect can thus be performed on the basis of the evaluation table formed as a diagram or as a formula expression.

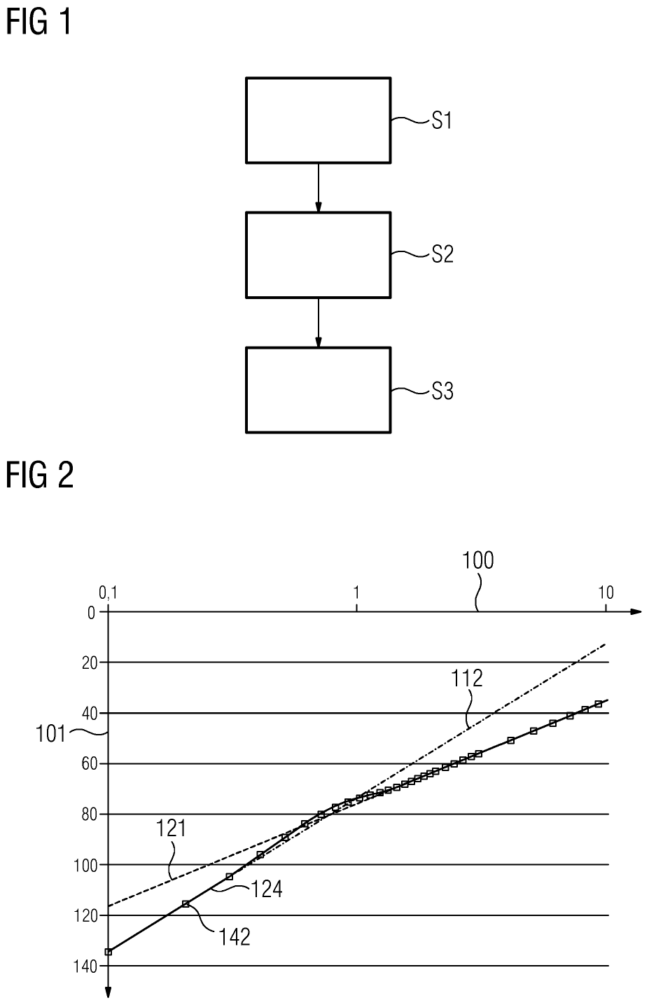

FIG. 1 shows a schematic flow chart of an example method incorporating teachings of the present disclosure for creating an evaluation table.

In a first step S1, a simulation of a scattering of ultrasound on at least one defect having an established defect size is performed by means of a computer-implemented two-dimensional or three-dimensional simulation. For this purpose, the defect size is less than or equal to the wavelength of the ultrasound. Furthermore, a mode conversion of the ultrasound by the defect is taken into consideration by the simulation. In other words, the most complete possible physical simulation is performed of the scattering of the ultrasound at the defect provided within the simulation.

In a second step S2, the reflectivity of the defect is ascertained from the simulation, for example, based on a maximum value, which is associated with the defect, of the absolute value of a time-dependent amplitude of the ultrasound reflected at the defect. In this case, the ascertainment of the reflectivity can be performed in particular on a SAFT analysis of the computed time-dependent amplitudes (A images).

In a third step S3, the evaluation table is created by means of an assignment of the ascertained reflectivity to the established defect size of the defect. In other words, the reflectivity ascertained by means of the simulation is correlated with the defect size used in the simulation. In general, the evaluation table is to be understood as a correlation between the reflectivity and the defect size. In other words, precisely one defect size results from a fixed predetermined reflectivity.

The evaluation table can be provided in tabular form, wherein one column of the table is assigned to the reflectivity and a further column of the table is assigned to the defect size. By means of the evaluation table created, an evaluation and defect identification can be performed during the ultrasonic inspection of the object. In particular, defects having a defect size less than the wavelength of the employed ultrasound can be detected and evaluated using the evaluation table according to the invention.

Defects having a defect size less than the wavelength of the ultrasound employed during the ultrasonic inspection can thus advantageously be assigned an equivalent defect size.

FIG. 2 shows a comparison diagram of a simulation with a theoretical model of the reflectivity of the ultrasound. The defect size is logarithmically plotted in the unit millimeters (mm) on the abscissa 100 of the comparison diagram shown. The defect is formed by way of example as a circular disk in this case. The amplification (gain) of the ultrasonic signal is plotted in the unit decibels (dB) on the ordinate 101. In other words, the dependence of the scaled amplitude |A/A₀| on the defect size D_{f} is plotted double-logarithmically.

In this case, the amplification corresponds to the acquired reflectivity of ultrasound reflected at the defect. The ultrasound reflected at the defect is acquired as the time-dependent amplitude. A dashed line 121 denotes a classical distance-amplification-size evaluation (abbreviated: DAS method). It extends essentially linearly in the illustrated double-logarithmic plotting. The dashed line thus corresponds to a dependence of the amplitude which is proportional to the square of the defect size, i.e. A∝D_{f}².

Furthermore, a dot-dash line 112 is shown, which is based on a dependence of the amplitude proportional to the third power of the defect size, i.e. A∝D_{f}³. The dot-dash line 112 therefore has a greater slope than the dashed line 121. Furthermore, the dot-dash line 112 also extends linearly.

The simulated curve of the reflectivity or the amplification, respectively, in dependence on the defect size is provided by the data points 142 of a simulation of the defect having the respective defect size. For reasons of comprehensibility, only one of the data points is identified by the reference sign 142. An inflection can be seen within the mentioned curve. The inflection corresponds to a transition of the dependence of the amplitude from A∝D_{f}³ for small defect sizes to A∝D_{f}² for large defect sizes. The lines 121, 112 thus each correspond to an asymptotic range of the data points 142.

The ascertained data points 142, which reflect the curve of the amplification V in punctiform manner, can be fitted by means of (see also formula expressions mentioned in the description)

$$V = 20 \cdot {log}_{10} \vert \frac{{( ix )}^{3}}{\sqrt{1 + \frac{ix}{Q} - {x}^{2}}} \cdot {( \frac{π D}{16 s} )}^{2} \vert$$

wherein x=4D_{f}/λ, and D_{f} denotes the defect size, D denotes an oscillator diameter of a test head, λ denotes the wavelength of the ultrasound, Q denotes the fit parameter, and s denotes the sound path. The symbol i denotes the imaginary unit.

The fit is illustrated by the solid line 124 and displays a very good correspondence to the data points 142 numerically ascertained by means of the simulation. An evaluation of an ultrasonic inspection of an object can be performed by means of the illustrated diagram. If, for example, for an acquired time-dependent amplitude of an ultrasonic signal, an amplification of approximately 83 dB is required, this thus corresponds according to the illustrated diagram to an exemplary defect size of approximately 1 mm. In other words, by means of the evaluation table, which can correspond in its graphic representation to the diagram shown, defects having a defect size less than the wavelength of the employed ultrasound can be detected and the size and/or equivalent defect size thereof can be ascertained.

Although the teaching herein are illustrated and described in greater detail by the exemplary embodiments, the scope of the disclosure is not thus restricted by disclosed examples or other variations can be derived therefrom by a person skilled in the art without leaving the scope thereof.

What is claimed is:

1. A method for creating an evaluation table for an ultrasonic inspection of an object, the method comprising:
simulating a scattering of ultrasound on a defect having an established defect size using a computer-implemented two-dimensional or three-dimensional simulation, wherein the defect size is less than or equal to the wavelength of the ultrasound and the simulation takes into consideration a mode conversion of the ultrasound by the defect;
ascertaining the reflectivity of the defect from the simulation; and
creating the evaluation table by means of an assignment of the ascertained reflectivity to the established defect size of the defect.

2. The method as claimed in claim 1, wherein the simulation is based at least in part on finite differences.

3. The method as claimed in claim 1, wherein ascertaining the reflectivity includes using an Auld reciprocity theorem.

4. The method as claimed in claim 1, wherein the simulation is exclusively performed in a subregion of the object surrounding the defect.

5. The method as claimed in claim 4, wherein the simulation of the propagation of the ultrasound from its incidence position to the subregion is performed by means of an elastodynamic point source synthesis.

6. The method as claimed in claim 1, wherein ascertaining the reflectivity depends on the following relationship:
$$R = {( \frac{π D}{16 s} )}^{2} \vert \frac{{( ix )}^{3}}{\sqrt{1 + \frac{ix}{Q} - {x}^{2}}} \vert$$
wherein x=4D_{f}/λ, and D_{f} denotes the defect size, D denotes an oscillator diameter of a test head, λ denotes the wavelength of the ultrasound, Q denotes a fit parameter, and s denotes the sound path.

7. The method as claimed in claim 1, in which wherein ascertaining the reflectivity based at least in part on the following relationship:
$$R \approx \frac{{x}^{3}}{\sqrt{\vert 1 + ix - {x}^{2} \vert}} \cdot {( \frac{π D}{16 s} )}^{2}$$
wherein x=4D_{f}/λ, and D_{f} denotes the defect size, D denotes an oscillator diameter of a test head, λ denotes the wavelength of the ultrasound, Q denotes a fit parameter, and s denotes the sound path.

8. The method as claimed in claim 1, further comprising validating the simulation using a comparison ultrasonic inspection on at least one produced defect;
wherein the defect size of the produced defect is greater than the wavelength of the ultrasound used during the comparison ultrasonic measurement.

9. The method as claimed in claim 1, in which the evaluation table is ascertained as a diagram or formula expression.

10. A method for the ultrasonic inspection of an object, the method comprising:
radiating ultrasound onto at least one volume element of the object;
acquiring at least one ultrasound reflected from the volume element because of at least one defect;
determining the reflectivity by means of the absolute value of a time-dependent amplitude of the reflected ultrasound for the volume element; and
ascertaining a defect size associated with the determined reflectivity by means of an evaluation table created by:
simulating a scattering of ultrasound on a defect having an established defect size using a computer-implemented two-dimensional or three-dimensional simulation, wherein the defect size is less than or equal to the wavelength of the ultrasound and the simulation takes into consideration a mode conversion of the ultrasound by the defect;
ascertaining the reflectivity of the defect from the simulation; and
creating the evaluation table by means of an assignment of the ascertained reflectivity to the established defect size of the defect.

11. The method as claimed in claim 10, in which the determination of the reflectivity is based on a SAFT analysis.
